(19) United States
(12) Patent Application Publication
(10) Pub. No.: US 2025/0116160 A1
(43) Pub. Date: Apr. 10, 2025

(54) GEOSTEERING OPTIMIZATION

(71) Applicant: Schlumberger Technology Corporation, Sugar Land, TX (US)

(72) Inventors: Daria Ponomareva, Abu Dhabi (AE); Hussein Mustapha, Abu Dhabi (AE); Samat Ramatullayev, Abu Dhabi (AE)

(21) Appl. No.: 18/908,329

(22) Filed: Oct. 7, 2024

Related U.S. Application Data
(60) Provisional application No. 63/588,589, filed on Oct. 6, 2023.

(51) Int. Cl. E21B 7/04; G05B 13/02; G05B 13/04

(52) U.S. Cl. CPC E21B 7/04; G05B 13/0265; G05B 13/048; E21B 2200/20

(57) ABSTRACT

Certain aspects of the disclosure provide for systems and methods for geosteering a wellbore using an ensemble of machine learning models. The method may include processing one or more inputs with a first machine learning model trained to infer an updated geological model associated with the wellbore. The method may further include processing with a second machine learning model trained to generate a geosteering recommendation for the wellbore, one or more of: the updated geological model, drilling data from one or more offset wells, drilling requirements associated with the wellbore, or completion requirements associated with the wellbore to the second machine learning model. The method may further include outputting the geosteering recommendation for the wellbore.

### CROSS-REFERENCE TO RELATED APPLICATIONS

This application claims the benefit of and priority to U.S. Provisional Patent Application No. 63/588,589 filed on Oct. 6, 2023, the entire contents of which are hereby incorporated by reference.

### BACKGROUND

### Field

Aspects of the present disclosure relate to geosteering optimization, management, and control.

### Description of Related Art

Well construction and field development, e.g., preparation of a site for oil production, increasingly involves the drilling of directional wells (e.g., non-vertical wells) to reach a reservoir of one type or another (e.g., oil, gas, water, etc.). Often the geology of an underground field is complex and target reservoirs may be “thin” in the vertical dimension. Consequently, increasing contact with a reservoir with a wellbore requires precise directional drilling through varying underground geologic formations. Further complicating the process, fractures and/or faults in the geology may be hidden within field formations and may frustrate efforts to drill in a precise direction. Effective directional drilling of a wellbore generally depends on the specific geological features of the field and path of the wellbore.

Directional drilling often involves intentional deviation of the wellbore from its natural path (e.g., following a geologic formation), such as to direct the wellbore towards the target reservoir, which adds complexity to the drilling process. For example, drilling a wellbore may include drilling vertical, curved, and/or horizontal sections. Each section requires different drilling techniques. A vertical or curved section of a wellbore may be minimally impacted by formation dip variations, e.g., variations in the inclination of a geological layer from horizontal. A horizontal section of a wellbore, on the other hand, may be significantly impacted by formation dip variations due to drilling both across and through variable dips. Various drilling operational parameters need to be adjusted based on the section type (e.g., horizontal or vertical) to direct the wellbore along the intended path as the drilling operation traverses the geology to reach its target reservoir. Mistakes may result in missing the target reservoir, reducing contact with the target reservoir, and even wellbore failure, which are both costly and environmentally problematic.

Geosteering is a method of optimizing a wellbore's contact with a target reservoir. In particular, geosteering involves intentional, directional control of downhole equipment while drilling the wellbore (which is referred to as the well after completion). Geosteering is generally the real-time or near real-time process of directing the drilling of a wellbore based on geological measurements captured during the drilling process (e.g., log data) in an effort maximize the wellbore's contact with the reservoir. The quality of the resulting well, including well productivity and stability, depends on effective geosteering.

Current geosteering methods rely on human intervention, namely a trained geologist needs to consider real-time acquired data (e.g. logs) and to manipulate models of the field's geology, in an effort to effectively direct a trajectory for the wellbore. Several technical challenges and insufficiencies arise with current geosteering methods. First, existing geological models are generally static and require manual updating and manipulation by a human. Further, these models may fail to predict challenging and complex geology. For example, current models may not be sufficient to account for drilling risks based on unforeseen geology, and may not account for other operational limitations. Second, existing workflows, which require human intervention, are slow. Research has shown that the effectiveness of geosteering is controlled in part by how quickly new data (e.g., well log data) can be integrated into existing models and used to affect geosteering decisions. Given the complexity of the overall workflow, human intervention is a bottleneck, resulting in a technical challenge that is impractical to perform using the human mind. Thus, current methods fail to provide a comprehensive model and a deterministic approach for geosteering.

Accordingly, there is a need in the art for improved geosteering methods to provide comprehensive geosteering management.

### SUMMARY

Certain aspects provide a method for management of geosteering of a wellbore, comprising: processing one or more inputs with a first machine learning model trained to infer an updated geological model associated with the wellbore; processing with a second machine learning model trained to generate a geosteering recommendation for the wellbore, one or more of: the updated geological model, drilling data from one or more offset wells, one or more drilling requirements associated with the wellbore, or one or more completion requirements associated with the wellbore to the second machine learning model; and outputting the geosteering recommendation for the wellbore.

Certain aspects provide a method for management of geosteering of a wellbore, comprising: training a first machine learning model to generate a first output, wherein the first output is a geological model; providing drilling data from one or more offset wells, one or more drilling requirements associated with the wellbore, and/or one or more completion requirements associated with the wellbore to a second machine learning model; providing the first output to the second machine learning model; and training the second machine learning model to generate a second output based on the first output, wherein the second output is a geosteering recommendation.

Other aspects provide one or more apparatuses or one or more processing systems configured to perform the aforementioned methods as well as those described herein; one or more non-transitory, computer-readable media comprising instructions that, when executed by one or more processors of a processing system or of apparatus(es), cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example process flow for geosteering in accordance with examples of the present disclosure.

FIG. 2 depicts an example visualization of a geological model for geosteering for a wellbore.

FIG. 3 depicts a method of managing geosteering for wellbore drilling in accordance with examples of the present disclosure.

FIG. 4 depicts a method of training a model for geosteering wellbore drilling in accordance with examples of the present disclosure.

FIG. 5 depicts an example processing system on which aspects of the present disclosure can be performed.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for performing geosteering during wellbore drilling. Certain aspects provide systems and methods for dynamic geological modeling and generating geosteering recommendations together with prediction of rate of penetration, number of drilling trips, drilling risks (e.g., fishing, fluid influx, lost circulation, tool failure, stuck pipe, twist off, wellbore instability), success rate of lower completion deployment and production rate. Certain aspects further provide techniques for training and/or utilizing an ensemble of machine learning models to model geosteering and generate geosteering recommendations to improve geosteering and thereby well quality and productivity.

As above, geosteering refers to the process of actively directing wellbore directional drilling in order to reach and maximize contact with a target reservoir. Geosteering balances various geological factors associated with a field and various operational requirements associated with drilling equipment to achieve a successful and productive well. Mistakes in geosteering may result in re-steering, which may require delays and additional drilling, increased wear on drilling equipment, increased environmental impacts, and may ultimately result in project failure.

Existing methods rely on a geological model representing the underground geological substructures of the field. A geologist then processes real-time acquired data (e.g. logs) and updates the geological model manually. The geologist is then tasked with determining the necessary drilling parameters based on their interpretation of the model such as what trajectory to direct the wellbore to maximize productivity of the well. While the geological model may provide a simulation of the geological field, it rarely provides a deterministic output for managing the geosteering process, for example, for determining appropriate drilling parameters, completion parameters, risks associated with each of the foregoing parameters, and the like.

Aspects described herein provide technical solutions to overcome the aforementioned technical limitations of existing methods through an ensemble geosteering model architecture trained to generate geosteering recommendations based on real-time or near real-time data generated during the drilling process. In particular, the ensemble architecture includes a first machine learning model trained to update a geological model based on drilling data (e.g., logs of porosity, permeability, saturation, formation image) acquired in real-time or near real-time during the drilling process. The output of the first machine learning model is an updated geological model used to perform production forecast of the drilled well of interest using either physics-based or data-driven methods. The output of the first machine learning model also serves as an input to a second machine learning model trained to generate geosteering recommendations with a prediction of rate of penetration, number of drilling trips, drilling risks (e.g. fishing, fluid influx, lost circulation, tool failure, stuck pipe, BHA twist off, wellbore instability), success rate of lower completion deployment and production rate. The ensemble architecture as a whole may be further configured to address operational constraints, such as drilling and completion requirements. Notably, the ensemble architecture described herein overcomes the technical difficulties and insufficiencies of existing processes that require human intervention to update the geological model. Further, the ensemble architecture described herein produces more accurate and repeatable geosteering recommendations that improve the efficiency (e.g., by reducing machinery wear and tear and reducing material use) and reduce the environmental impact of drilling operations.

Notably, the ensemble architecture described herein effectively addresses a computationally complex problem that is not capable of being performed in the human mind.

### Example Process Flow for Optimizing Geosteering

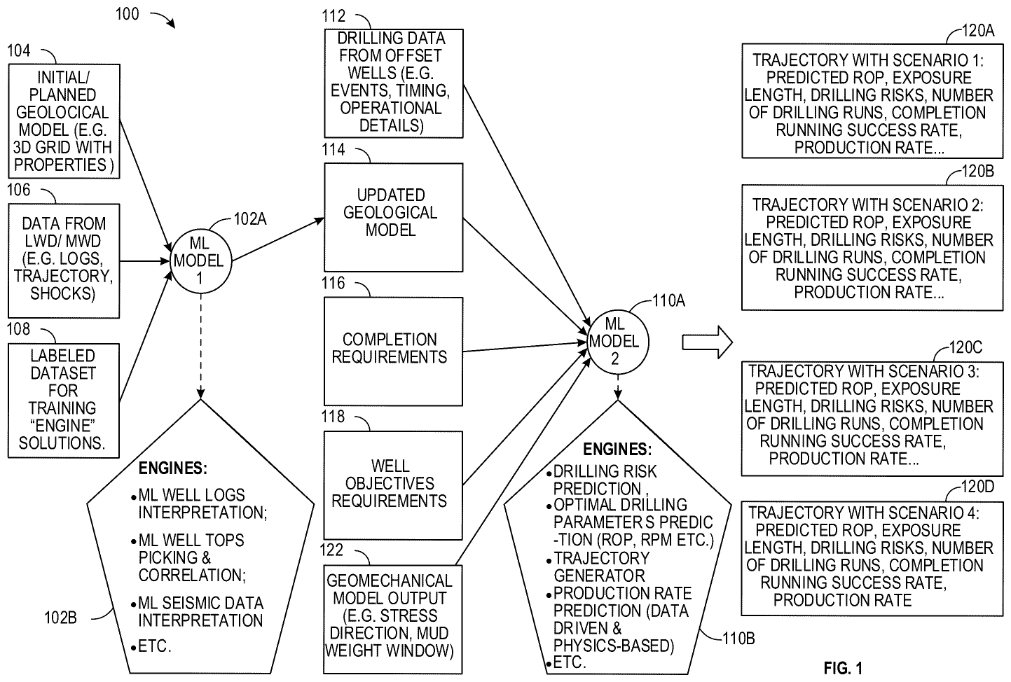

FIG. 1 depicts an example process flow 100 for geosteering, according to aspects described herein. Process flow 100 operates an ensemble architecture including multiple trained machine learning models, which in this example includes models 102A and 110A.

Model 102A is configured to process one or more of a planned geological model 104, measurements 106, and historical data 108 to infer an updated geological model 114. In some cases, model 102A may be a machine learning model trained using machine learning algorithms (e.g., decision trees, gradient boosting machines, ensemble models, clustering algorithms, anomaly detection algorithms, etc.). In some cases, model 102A may be trained using advanced deep learning algorithms (e.g., feedforward neural networks, convolutional neural networks, recurrent neural networks, graph neural networks, long short-term memory networks, auto encoders, transformer models, deep reinforcement learning algorithms, etc.). Specifically, model 102A may be trained to perform automated logs interpretation, well tops identification and correlation, and seismic interpretation (e.g. seismic data conditioning, horizon tracking and relative geological time modeling, stratigraphy and fault detection) around the subject well. Further, the model 102A may be conditioned to the acquired real-time data and output, via an automated workflow, an updated geological model 114. The updated geological model 114 is used to forecast production of the drilled well of interest using either physics-based or data-driven methods based on these various inputs, as described in further detail below. The updated geological model 114 inferred by model 102A may include one or more geomechanical parameters (also referred to as geomechanical properties, or geomechanical effects), such as mechanical deformation, stress, strain, propensity for fracture and/or fault, and/or the like, such as arising from the geological formation.

Model 102A may include one or more engines 102B configured to process input data to predict the output. For example, in some aspects, engines 102B may include an engine configured to interpret well logs, an engine configured to pick and correlate well tops, and an engine configured to interpret seismic data.

Planned geological model 104 may generally be a static geological model representing the geological features of the field, for example, capturing the spatial distributions and properties of rock layers, faults, fractures, and the like, based on available geological and geophysical data. This data includes measured geological features of the field and geological mechanical properties, such as Young's modulus, Poisson's ratio, and/or compressive/tensile strengths. Planned geological model 104 may further incorporate petrophysical properties like porosity, permeability, and mineralogy. Planned geological model 104 may delineate key static features like reservoir boundaries, caprock extents, and structural features, such as formation dip variations, critical to the geosteering process. Further, planned geological model 104 may statically represent subsurface geological structures and rock properties, but does not simulate any dynamic processes over time.

Measurements 106 is another input to model 102A. Measurements 106 may include well positioning (depth, inclination and azimuth) and logging data.

In some aspects, measurements 106 may include measurements while drilling (MWD) data. MWD data may include measurements of physical properties downhole, for example, pressure, temperature and wellbore trajectory, etc. Such measurements may be obtained through one or more sensors, for example, a pressure sensor, a temperature sensor, an accelerometer, a magnetometer, and the like. In some aspects, MWD data is measured downhole, and later transmitted to the surface.

In some aspects, measurements 106 may include logging while drilling (LWD) data. LWD data may include measurements of formation properties, e.g., the geological formations associated with the wellbore and their properties (e.g., porosity, permeability, saturation, mineralogy). Such measurements may be obtained through one or more sensors associated with a bottomhole assembly (BHA).

In some aspects, measured 106 may include other data associated with the drilling operation. For example, drilling data may include one or more operational parameters of the drilling operation, drilling parameters, well path, target reservoir, and the like. In some aspects, measurements 106 may include seismic data associated with the drilling operation.

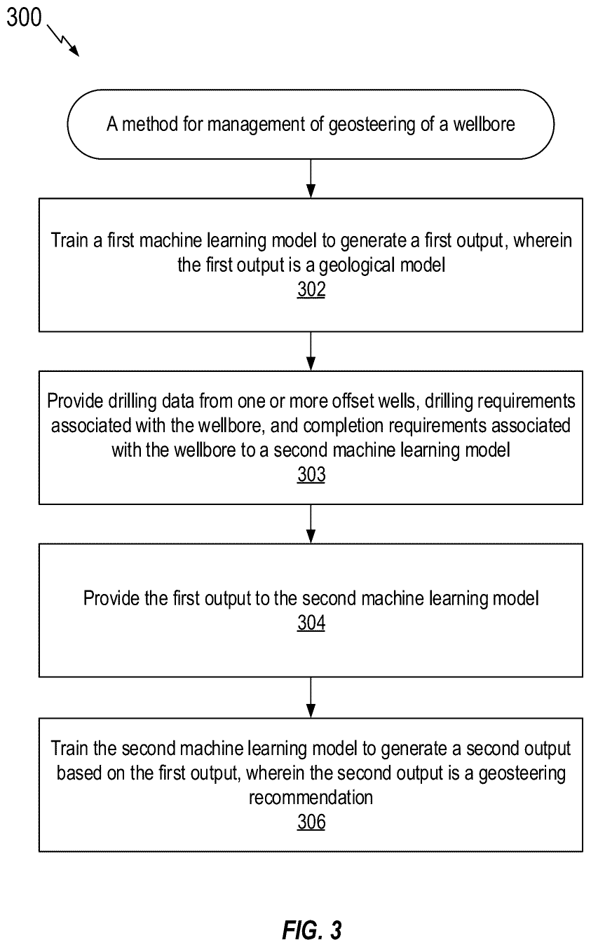

Model 102A may be trained using historical data 108, comprising one or more labeled datasets, as described with respect to FIG. 3.

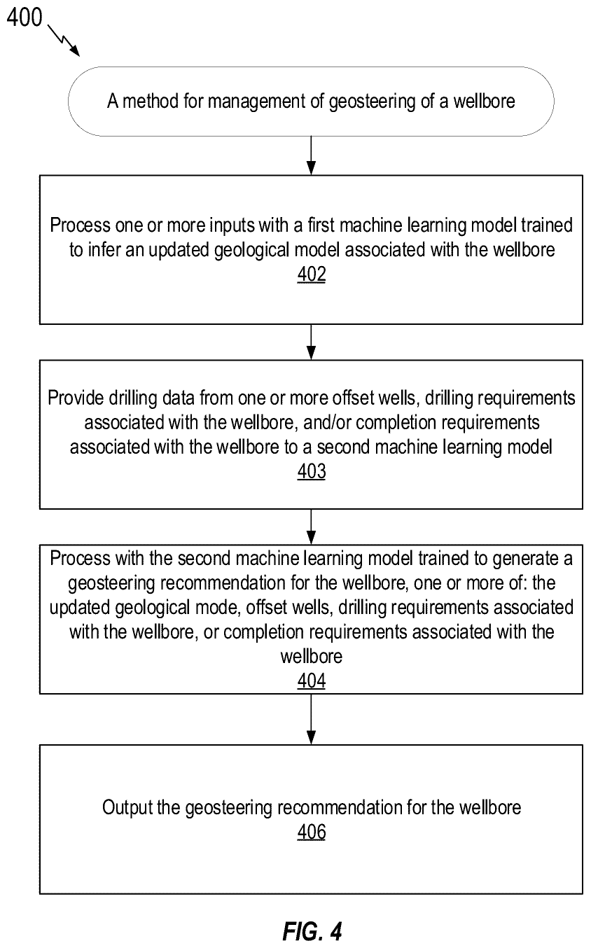

As described herein, for example with respect to FIGS. 3 and 4, model 102A is trained to infer the updated geological model 114 based on logging data. Model 102A performs automated logs interpretation, well tops identification and correlation, and seismic interpretation (e.g. seismic data conditioning, horizon tracking and relative geological time modeling, stratigraphy and fault detection) around the subject well and conditions the model 102A to the acquired real-time data. Model 102A may also analyze the mechanical stresses, strains, and/or deformations in subsurface rocks under various loading conditions to infer the updated geological model 114. The updated geological model 114 may predict production rate of the drilled well of interest based either on physics-based reservoir simulator or data-driven algorithms, or simulate how rocks mechanically respond to changes in stress, pressure, and/or loading over time, such as throughout the drilling process. For example, the updated geological model 114 may simulate earth stresses, deformations, and failure from drilling activities and its impact on well productivity. Further, the updated geological model 114 may predict stress distribution, fracture propagation, subsidence, sand production, and/or other geomechanical effects.

Beneficially, updated geological model 114 may be revised as the additional data is provided to model 102A, for example, additional logs as measurements 106 as drilling continues. Model 102A may infer one or more revisions to updated geological model 114 based on the additional input data associated with the field. For example, the one or more revisions to the updated geological model 114 may include a revision to one or more projections and/or predictions of the production rate of the drilled well of interest. In some cases, the revision to one or more projections and/or predictions of the production rate of the drilled well of interest may be based on either physics-based reservoir simulations and/or data-driven algorithms. Further, downstream modelling, e.g., model 110A, may beneficially be improved by utilizing the revisions to the updated geological model 114. Specifically, geosteering improves based on rapid reaction to geological changes, such as modeled in the revisions to the updated geological model 114 together with processing the offset wells drilling data (e.g., logs, daily drilling reports, bits, bottomhole assemblies, trajectories, rate of penetration, weight on bit, drill bit revolution) and other data imposing an additional constraints on the planned trajectory.

Model 110A is a trained machine learning model configured to process updated geological model 114 outputted by model 102A, together with processing the offset wells drilling data (e.g. logs, daily drilling reports, bits type, bottomhole assemblies type, trajectories, rate of penetration, weight on bit, drill bit revolution) and other data imposing additional constraints on the planned trajectory to infer one or more geosteering recommendations. In some aspects, the one or more geosteering recommendations may include a prediction of rate of penetration, a number of drilling trips, drilling risks (e.g. fishing, fluid influx, lost circulation, tool failure, stuck pipe, BHA twist off, wellbore instability), a success rate of lower completion deployment and a production rate, for example, recommendation 120A, recommendation 120B, recommendation 120C, and/or recommendation 120D (collectively, “recommendations 120”), as described in further detail with respect to FIGS. 3 and 4.

Model 110A may include one or more engines 110B configured to process this input data to generate the output. In some aspects, the one or more engines 110B may comprise an engine configured to predict drilling risk, an engine configured to optimize predicted drilling parameters (e.g., ROP, RPM, etc.), an engine configured to generate a trajectory prediction, or an engine configured to predict a production rate prediction, in some cases, based on either on physics-based reservoir simulator or data-driven algorithms.

Model 110A is further configured to process various additional inputs, including drilling data 112. Drilling data 112 may include data from one or more offset wells. An offset well is an existing wellbore close to the current wellbore, e.g., in the same field. One or more offset wells are drilled in the field to obtain field data, including the subsurface geology and pressure regimes.

In some aspects, drilling data 112 may include both high-frequency data and low-frequency data. High-frequency data may be, for example, data obtained from one or more sensors associated with the drilling apparatus, such as weight on a bit, flow rate of drilling fluid, surface rotation and rotation of a bit, and the like. Such high-frequency data may be obtained, for example, every two seconds, every five seconds, etc. Low-frequency data may be, for example, data obtained as a summary and/or report of drilling operations. Such low-frequency data may be obtained, for example, daily. Beneficially, high-frequency data may be processed by model 110A more frequently than low-frequency data. In some aspects, different weightings may be applied to high-frequency data compared to low-frequency data for processing by model 110A.

Drilling data 112 may have additional data. This additional data may include data pertaining to events during the drilling of the one or more offset wells, such as adverse events like wellbore failure or collapse, fishing, fluid influx, lost circulation, tool failure, stuck pipe, or bottomhole assembly twist off. This additional data may further include data pertaining to operational parameters during the drilling of the one or more offset wells, such as timing, drilling parameters, and the like. Beneficially, this additional data may inform recommended operational parameters and production rate for the current wellbore, such as may be included as part of a generated geosteering recommendation by model 110A.

Model 110A is further configured to process one or more operational requirements, including completion requirements 116 and well objective requirements 118, as additional inputs. Such completion requirements 116 may include one or more requirements for completing the well (e.g. selection of intervals, type of completion, treatment methods, dog leg severity, wellbore quality, average caliper reading) following drilling operations. These requirements may be based on the type of completion, for example, the type of processes and components used to ready the well for production. Model 110A, then, beneficially generates geosteering recommendations 120 to conform with the completion requirements 116.

Such well objective requirements 118 may include one or more requirements for the well, one or more purposes of the well, and the like. Well requirements may include construction requirements of the well, for example, the wellbore diameter, depth, starting and/or ending location, trajectory, logging requirements, and the like. Well purposes may include the motivation or type of the well, for example, an exploration well, an appraisal well, a development well, and the like. Model 110A, beneficially, generates geosteering recommendations 120 to conform with the well objective requirements.

In some aspects, an operational requirement may further include a required rate of penetration (ROP), a required number of bottomhole assemblies, and the like, for the drilling operation. In some aspects, an operational requirement may further include operational constraints, and/or facility constraints, for example, a maximum number of trips, bits used, and the like, for the drilling operation. Beneficially, geosteering recommendations generated by model 110A may comply with one or more operational requirements.

Model 110A is further configured to process one or more outputs 122 of a geomechanical model as additional inputs. The one or more outputs 122 of the geomechanical model may be based on simulations performed with the geomechanical model. The one or more outputs 122 of the geomechanical model may include, for example, a stress direction, a mud weight window corresponding to the safe weight of the mud used during drilling to prevent collapse, and the like. In some embodiments, the geomechanical model may be the planned geological model 104.

Model 110A is trained to output one or more geosteering recommendations 120 in a structured format based on the various inputs, including the updated geological model 114, the drilling data 112, the completion requirements 116 and/or the well objective requirements 118 as described. In some aspects, model 110A may be a recommendation model. In some cases, model 110A may be a machine learning model trained using machine learning algorithms (e.g., decision trees, gradient boosting machines, ensemble models, clustering algorithms, anomaly detection algorithms, etc.). In some cases, model 110A may be trained using advanced deep learning algorithms (e.g., feedforward neural networks, convolutional neural networks, recurrent neural networks, graph neural networks, long short-term memory networks, auto encoders, transformer models, deep reinforcement learning algorithms, etc.).

A geosteering recommendation 120 may comprises a predicted rate of penetration, a number of drilling trips, one or more drilling risks, a success rate of lower completion deployment, or a production rate.

For example, a geosteering recommendation 102 may include a predicted ROP, a predicted exposure length, one or more drilling risks, a predicted number of drilling runs, predicted completion running success rate, adverse event risk, production rate, and the like. The geosteering recommendation may be outputted in a structured format, for example, trajectories will be in terms of tables with numerical values to be read by a software application, such as the PETREL® framework. For each depth, there would be corresponding drilling risks that can be propagated around the wellbore. The ROP and production predictions will be numerical values etc.

For example, a first recommendation 120A includes a first projected trajectory and details the potential outcomes, associated risks, and production rates with that first projected trajectory. As another example, a second recommendation 120B includes a second projected trajectory and details the potential outcomes, associated risks, and production rates with the second projected trajectory. Similarly, additional recommendations, such as a third recommendation 120C, and a fourth recommendation 120D, may include additional trajectories. Although four recommendations are depicted in this example, any number of recommendations may be generated with model 110A.

In some aspects, model 110A is further trained to rank or score the one or more generated geosteering recommendations 120. For example, model 110A may determine a rank for each of first recommendation 120A, second recommendation 120B, third recommendation 120C, and fourth recommendation 120D. In some aspects, the rank may be based on compliance with the one or more operation requirements, the success rate, and/or the adverse event risk. In some aspects, the rank may be based on a comparison between the one or more generated geosteering recommendations. In some aspects, the rank may be based on satisfying one or more thresholds, for example, a threshold associated with a maximum drilling threshold, a minimum success rate, a minimum exposure length, and the like. A threshold may be satisfied when a generated recommendation meets or exceeds a minimum threshold, a generated recommendation meets or is inferior to a maximum threshold, and/or a generated recommendation falls within a threshold range.

In some aspects, process flow 100 may further include visualization, such as through a visualization component (not depicted). The visualization component may visually depict aspects of the ensemble of models. In some aspects, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. For example, the visualization component may be configured to depict the updated geological model 114, generated by model 102A, in one or more visual depictions. The updated geological model 114, for example, may be depicted as a well plan representing the geomechanical figure of the well path of the wellbore. In some aspects, the updated geological model 114 may be presented in a two-dimensional (e.g., 2D) or a three-dimensional (e.g., 3D) depiction. As another example, the visualization component be configured to depict the one or more geosteering recommendations 120 generated by model 110A depicted as part of, adjacent to, and/or separately from the updated geological model 114. In some aspects, the visualization component may depict the one or more geosteering recommendations 120 based on a rank or score.

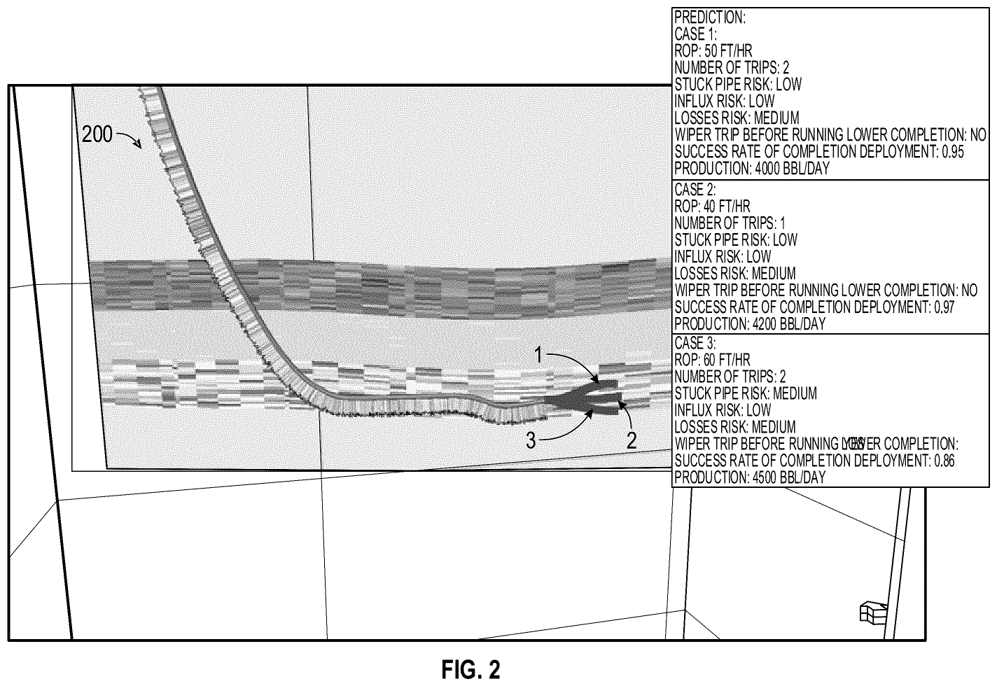

An exemplary visualization is depicted at FIG. 2, which visually displays a well path 200 and three different recommendations: case 1, case 2, and case 3. Case 1 is a first recommended trajectory 1, as well as a predicted ROP, a predicted number of trips, a predicted risk of stuck pipe, a predicted influx risk, a predicted losses risk, a prediction for a wiper trip, a predicted success rate of completion deployment, and a predicted production. Case 2 is a second recommended trajectory 2, as well as a predicted ROP, a predicted number of trips, a predicted risk of stuck pipe, a predicted influx risk, a predicted losses risk, a prediction for a wiper trip, a predicted success rate of completion deployment, and a predicted production. Case 3 is a third recommended trajectory 3, as well as a predicted ROP, a predicted number of trips, a predicted risk of stuck pipe, a predicted influx risk, a predicted losses risk, a prediction for a wiper trip, a predicted success rate of completion deployment, and a predicted production. Further, visualization features may include one or more control features for control of equipment, which can include, for example, field equipment that can perform one or more field operations. As an example, a process flow may utilize one or more frameworks to generate information that can be utilized to control one or more types of field equipment (e.g., drilling equipment, wireline equipment, fracturing equipment, etc.).

In certain aspects, one or more aspects of process flow 100 may be performed and/or implemented using features of a commercially available framework, such as the PETREL® seismic to simulation software framework (SLB, Houston, Texas). The PETREL® framework provides components that allow for optimization of exploration and development operations. The PETREL® framework includes geological model building and visualization software components that can output information for use in improved geosteering, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

Note that process flow 100 is just one example, and other flows including fewer, additional, or alternative steps, consistent with this disclosure, are possible.

### Example Training Method for Geosteering

FIG. 3 depicts an example method 300 for training an ensemble of machine learning models in accordance with examples of the present disclosure. Method 300 may be utilized for management of geosteering of a wellbore.

At step 302, a first machine learning model is trained to generate a first output, wherein the first output is an updated geological model. The updated geological model may, in some aspects, be used to predict a production rate of the drilled well of interest based either on physics-based reservoir simulator or data-driven algorithms. In some aspects, the first machine learning model may be model 102A described above with respect to FIG. 1, and the output is updated geological model 114 in FIG. 1. In some aspects, the first output is an update to one or more parts of a geological model input.

In some aspects, the first machine learning model may be trained to determine one or more revisions to the updated geological model based on additional input data from multiple wells drilled at different parts of the field. Beneficially, then, relevant regions of a field may be revised based on this additional data. Further, the model may be continuously revised (e.g., in real-time) as additional input data is provided.

In some aspects, the first machine learning model is trained with various input data. Such input data may include various geological models, for example, a static model. Input data may further include drilling data, such as measurements 106 in FIG. 1. As described herein, drilling data may include MWD (e.g., trajectory) data and/or LWD (e.g., logs) data.

In some aspects, the first machine learning model is trained with training data, the training data comprising one or more of: a static geological model, the drilling data for the wellbore, or historical data associated with one or more historical wellbores.

In some aspects, method 300 proceeds to step 303, where offset wells drilling data (e.g., logs, daily drilling reports, bits types, bottomhole assemblies types, trajectories, rate of penetration, weight on bit, drill bit revolution), geomechanical model output and other data (the completion requirements, the well objective requirements, and the like) are provided to a second machine learning model.

At step 304, the first output is provided to the second machine learning model. In some aspects, the first output is updated geological model 114 and the second machine learning model is recommendation model 110A in FIG. 1.

At step 306, the second machine learning model is trained with the first output together with offset wells drilling data (e.g., logs, daily drilling reports, bits types, bottomhole assemblies types, trajectories, rate of penetration, weight on bit, drill bit revolution), geomechanical model output, and other data (e.g., the completion requirements, the well objective requirements, and the like) to generate a second output, wherein the second output is a geosteering recommendation. In some aspects, the second output may comprise two or more geosteering recommendations. For example, the second machine learning model may one or more of first recommendation 120A, second recommendation 120B, third recommendation 120C, and fourth recommendation 120D.

In some aspects, the geosteering recommendation comprises a predicted rate of penetration, a number of drilling trips, one or more drilling risks (e.g. fishing, fluid influx, lost circulation, tool failure, stuck pipe, twist off, wellbore stability), a success rate of lower completion deployment and/or a production rate.

In some aspects, method 300 further comprises training the second machine learning model to generate a ranking associated with the geosteering recommendation for the wellbore.

In some aspects, method 300 further comprises sending, to a field equipment, the geosteering recommendation for the wellbore.

In some aspects, method 300 further comprises providing additional drilling data for the wellbore to the first machine learning model; and training the first machine learning model to determine one or more revisions to the updated geological model associated with the wellbore based on the additional drilling data.

In some aspects, the updated geological model associated with the wellbore comprises one or more geomechanical parameters of the wellbore, including a mechanical deformation parameter, a stress parameter, a strain parameter, a propensity for fracture parameter, or a propensity for fault parameter.

In some aspects, the updated geological model associated with the wellbore associated with the wellbore comprises a predicted production rate of the wellbore.

In some aspects, the first machine learning model and the second machine learning model are trained independently.

In accordance with the examples of the present disclosure, once trained, the ensemble of machine learning models performs one or more interference operations, for example, as described with respect to FIG. 4.

Note that method 300 is just one example, and other methods including fewer, additional, or alternative steps, consistent with this disclosure, are possible.

### Example Inferencing Method for a Geosteering Optimizer

FIG. 4 depicts an example method 400 for generating an inference with an ensemble of machine learning models in accordance with examples of the present disclosure. Method 400 may be utilized for the management of geosteering of a wellbore.

Method 400 begins at step 402 with processing one or more inputs, such as logs acquired in real-time data (e.g., porosity, permeability, saturation, formation image), with a first machine learning model trained to perform automated logs interpretation, well tops identification and correlation, seismic interpretation (e.g. seismic data conditioning, horizon tracking and relative geological time modeling, stratigraphy and fault detection) around a subject well and conditioning the first machine learning model to the acquired real-time data. The first machine learning model is further trained to infer an updated geological model associated with the wellbore, as well as an optimized trajectory. In some aspects, the first machine learning model may be model 102A in FIG. 1.

In some aspects, the one or more inputs comprise a static geological model and drilling data (e.g. offset wells logs, daily drilling reports, bits, bottomhole assemblies, trajectories, rate of penetration, weight on bit, drill bit revolution) for the wellbore and the completion requirements, the well objective requirements, and the like.

In some aspects, the updated geological model associated with the wellbore comprises one or more geomechanical parameters of the wellbore, including a mechanical deformation parameter, a stress parameter, a strain parameter, a propensity for fracture parameter, or a propensity for fault parameter.

In some aspects, the updated geological model associated with the wellbore associated with the wellbore comprises a predicted production rate of the wellbore.

Method 400 proceeds to step 403 with providing offset wells drilling data (e.g. logs, daily drilling reports, bits, bottomhole assemblies, trajectories, rate of penetration, weight on bit, drill bit revolution, etc.) and/or other data to a second machine learning model.

Method 400 then proceeds to step 404 with processing with the second machine learning model trained to generate a geosteering recommendation for the wellbore, one or more of: the updated geological model the offset wells drilling data (e.g. logs, daily drilling reports, bits, bottomhole assemblies, trajectories, rate of penetration, weight on bit, drill bit revolution, etc.) or other data imposing additional constraints on the optimized trajectory. The second machine learning model may be recommendation model 110A in FIG. 1.

Method 400 then proceeds to step 406 with outputting the geosteering recommendation for the wellbore. A geosteering recommendation may include a predicted ROP, an exposure length, one or more drilling risks (e.g., fishing, fluid influx, lost circulation, tool failure, stuck pipe, twist off, wellbore stability), a number of drilling runs, completion running success rate, adverse event risk, success rate of lower completion deployment and production rate, and the like.

In some aspects, the geosteering recommendation comprises a predicted rate of penetration, a number of drilling trips, one or more drilling risks, a success rate of lower completion deployment, or a production rate.

In some aspects, method 400 further comprises generating a ranking associated with the geosteering recommendation for the wellbore. In some aspects, a geosteering recommendation generated by the second machine learning model may be outputted where the ranking satisfies a threshold.

In some aspects, method 400 further comprises providing drilling data from one or more offset wells, one or more drilling requirements associated with the wellbore, and/or one or more completion requirements associated with the wellbore to the second machine learning model.

In some aspects, method 400 further comprises sending, to a field equipment, such as drilling equipment, wireline equipment, fracturing equipment, etc., the geosteering recommendation for the wellbore. In some aspects, the field equipment is controlled based on the geosteering recommendation, for example, one or more operational parameter provided in the recommendation.

In some aspects, method 400 further comprises providing additional drilling data for the wellbore to the first machine learning model; and determining one or more revisions to the updated geological model associated with the wellbore with the first machine learning model based on the additional drilling data.

In some aspects, method 400 further comprises generating a second geosteering recommendation with the second machine learning model based on the one or more revisions to the updated geological model associated with the wellbore and the additional drilling data.

Note that method 400 is just one example, and other methods including fewer, additional, or alternative steps, consistent with this disclosure, are possible.

### Example Processing System for Geosteering Optimization

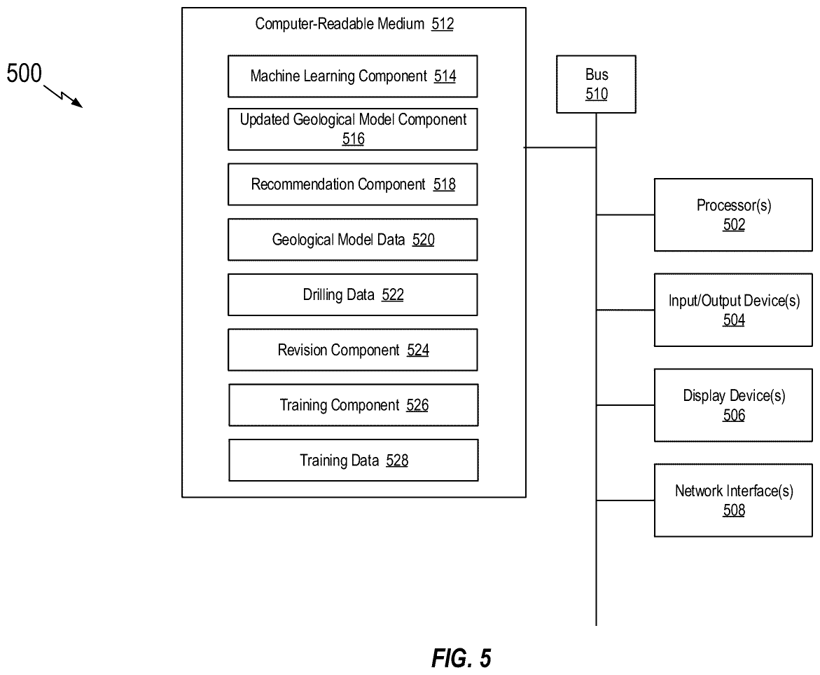

FIG. 5 illustrates an example of processing system 500, in accordance with some aspects, for example, method 300 as described above with respect to FIG. 3, method 400 as described above with respect to FIG. 4.

The processing system 500 is generally an example of an electronic device configured to execute computer-executable instructions, such as those derived from complied computer code, including without limitation, personal computers, tablet computers, servers, smart phones, smart devices, wearable devices, augmented and/or virtual reality devices, and others.

In the depicted example, processing system 500 includes, one or more processors 502, one or more input/output devices 504, one or more display devices 506, one or more network interfaces 508 through which processing system 500 is connected to one or more networks (e.g., a local network, an intranet, the Internet, or any other group of processing systems communicatively connected to each other), and computer-readable medium 512. In the depicted example, the aforementioned components are coupled by a bus 510, which may generally be configured for data exchange amongst the components. Bus 510 may be representative of multiple buses, while only one is depicted for simplicity. Processor(s) 502 are generally configured to retrieve and execute instructions stored in one or more memories, including local memories like computer-readable medium 544, as well as remote memories and data stores. Similarly, processor(s) 502 are configured to store application data residing in local memories like the computer-readable medium 544, as well as remote memories and data stores. More generally, bus 510 is configured to transmit programming instructions and application data among the processor(s) 502, display device(s) 506, network interface(s) 508, and/or computer-readable medium 512. In certain aspects, processor(s) 502 are representative of a one or more central processing units (CPUs), graphics processing unit (GPUs), tensor processing unit (TPUs), accelerators, and other processing devices.

Input/output device(s) 504 may include any device, mechanism, system, interactive display, and/or various other hardware and software components for communicating information between processing system 500 and a user of processing system 500. For example, input/output device(s) 504 may include input hardware, such as a keyboard, touch screen, button, microphone, speaker, and/or other device for receiving inputs from the user and sending outputs to the user.

Display device(s) 506 may generally include any sort of device configured to display data, information, graphics, user interface elements, and the like to a user. For example, display device(s) 506 may include internal and external displays such as an internal display of a tablet computer or an external display for a server computer or a projector. Display device(s) 506 may further include displays for devices, such as augmented, virtual, and/or extended reality devices. In various aspects, display device(s) 506 may be configured to display a graphical user interface.

Network interface(s) 508 provide processing system 500 with access to external networks and thereby to external processing systems. Network interface(s) 508 can generally be any hardware and/or software capable of transmitting and/or receiving data via a wired or wireless network connection. Accordingly, network interface(s) 508 can include a communication transceiver for sending and/or receiving any wired and/or wireless communication.

Computer-readable medium 512 may be a volatile memory, such as a random access memory (RAM), or a nonvolatile memory, such as nonvolatile random access memory (NVRAM), or the like. In some aspects, computer-readable medium 512 includes one or more machine learning component(s) 514. In some aspects, a single machine learning module may be used to perform some aspects of the methods disclosed herein. In other aspects, a plurality of machine learning modules may be used to perform some aspects of methods described herein.

In some aspects, computer-readable medium 512 includes an updated geological model component 516 configured to perform production forecast of the drilled well of interest using either physics-based or data-driven methods. In some aspects, the updated geological model component 516 comprises one or more geomechanical parameters of the wellbore, including a mechanical deformation parameter, a stress parameter, a strain parameter, a propensity for fracture parameter, or a propensity for fault parameter. In some aspects, the updated geological model component 516 comprises a predicted production rate of the wellbore. In some aspects, the updated geological model component 516 comprises an output of the machine learning component 514.

In some aspects, computer-readable medium 512 includes a recommendation component 518 configured to use geosteering recommendations based on real-time or near real-time data generated during the drilling process. In some aspects, the recommendation component 518 comprises one or more of: a prediction of rate of penetration, a number of drilling trips, one or more drilling risks (e.g. fishing, fluid influx, lost circulation, tool failure, stuck pipe, BHA twist off, wellbore instability), a success rate of lower completion deployment and a production rate. In some aspects, the accurate and repeatable geosteering recommendations of recommendation component 518 improve the efficiency (e.g., by reducing machinery wear and tear and reducing material use) and reduce the environmental impact of drilling operation.

In some aspects, computer-readable medium 512 includes geological model data 520 including a static geological model, such as planned geological model 104, representing the geological features of the field, for example, capturing the spatial distributions and properties of rock layers, faults, fractures, and the like, based on available geological and geophysical data. This data includes measured geological features of the field and geological mechanical properties, such as Young's modulus, Poisson's ratio, and/or compressive/tensile strengths. The geological model data 520 may further incorporate petrophysical properties like porosity, permeability, and mineralogy. The geological model data 520 may delineate key static features like reservoir boundaries, caprock extents, and structural features, such as formation dip variations, critical to the geosteering process. Further, the geological model data 520 may statically represent subsurface geological structures and rock properties, but does not simulate any dynamic processes over time. In some aspects, the geological model data 520 may be an input to the machine learning component 514.

In some aspects, computer-readable medium 512 includes drilling data 522 including drilling data from one or more offset wells, drilling requirements associated with the wellbore, or completion requirements associated with the wellbore. In some aspects, drilling data 522 includes logs, daily drilling reports, bits, bottomhole assemblies, trajectories, rate of penetration, weight on bit, drill bit revolution, etc. In some aspects, drilling data 522 includes one or more operational parameters of the drilling operation, drilling parameters, well path, target reservoir, and the like. In some aspects, drilling data 522 may include both high-frequency data and low-frequency data. High-frequency data may be, for example, data obtained from one or more sensors associated with the drilling apparatus, such as weight on a bit, flow rate of drilling fluid, surface rotation and rotation of a bit, and the like. Such high-frequency data may be obtained, for example, every two seconds, every five seconds, etc. Low-frequency data may be, for example, data obtained as a summary and/or report of drilling operations. Such low-frequency data may be obtained, for example, daily.

In some aspects, drilling data 522 may include data pertaining to events during the drilling of the one or more offset wells, such as adverse events like wellbore failure or collapse, fishing, fluid influx, lost circulation, tool failure, stuck pipe, or bottomhole assembly twist off. This additional data may further include data pertaining to operational parameters during the drilling of the one or more offset wells, such as timing, drilling parameters, and the like.

In some aspects, computer-readable medium 512 includes a revision component 524 configured to determining one or more revisions to the updated geological model associated with the wellbore with the first machine learning model based on additional drilling data, such as subsequent data. In some aspects, the one or more revisions may be determined, at least in part, with the machine learning component 514. For example, the one or more revisions to the updated geological model may include a revision to one or more projections and/or predictions of the production rate of the drilled well of interest. In some cases, the revision to one or more projections and/or predictions of the production rate of the drilled well of interest may be based on either physics-based reservoir simulations and/or data-driven algorithms.

In some aspects, computer-readable medium 512 includes a training component 526 configured to train the machine learning component 514. For example, in some aspects, the training component 526 is configured to train a first machine learning model to generate a first output, wherein the first output is a geological model. In some aspects, the training component 526 is configured to train a second machine learning model to generate a second output based on the first output, wherein the second output is a geosteering recommendation. In some aspects, the training component 526 is configure to utilize training data 528 to train the machine learning component 514.

In some cases, training component 526 is configured to use machine learning algorithms (e.g., decision trees, gradient boosting machines, ensemble models, clustering algorithms, anomaly detection algorithms, etc.). In some cases, training component 526 is configured to use advanced deep learning algorithms (e.g., feedforward neural networks, convolutional neural networks, recurrent neural networks, graph neural networks, long short-term memory networks, auto encoders, transformer models, deep reinforcement learning algorithms, etc.).

Note that FIG. 5 is just one example of a processing system consistent with aspects described herein, and other processing systems having additional, alternative, or fewer components are possible consistent with this disclosure.

The foregoing description, for purpose of explanation, has been described with reference to specific aspects. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The aspects were chosen and described in order to best explain the principles of the disclosure and its practical applications, to thereby enable others skilled in the art to best utilize the disclosed aspects and various aspects with various modifications as are suited to the particular use contemplated.

### EXAMPLE CLAUSES

Implementation examples are described in the following numbered clauses:

Clause 1: A method for management of geosteering of a wellbore, comprising: processing one or more inputs with a first machine learning model trained to infer an updated geological model associated with the wellbore associated with the wellbore; processing with a second machine learning model trained to generate a geosteering recommendation for the wellbore, one or more of: the updated geological model, drilling data from one or more offset wells, one or more drilling requirements associated with the wellbore, or one or more completion requirements associated with the wellbore to the second machine learning model; and outputting the geosteering recommendation for the wellbore.

Clause 2: The method of clause 1, further comprising generating a ranking associated with the geosteering recommendation for the wellbore.

Clause 3: The method of any one of clauses 1-2, wherein the one or more inputs comprise one or more of: a static geological model or the drilling data for the wellbore.

Clause 4: The method of any one of clauses 1-3, wherein the updated geological model associated with the wellbore comprises one or more geomechanical parameters of the wellbore, including a mechanical deformation parameter, a stress parameter, a strain parameter, a propensity for fracture parameter, or a propensity for fault parameter.

Clause 5: The method of any one of clauses 1-4, wherein the updated geological model associated with the wellbore associated with the wellbore comprises a predicted production rate of the wellbore.

Clause 6: The method of any one of clauses 1-5, further comprising sending, to a field equipment, the geosteering recommendation for the wellbore.

Clause 7: The method of any one of clauses 1-6, wherein the geosteering recommendation comprises a predicted rate of penetration, a number of drilling trips, one or more drilling risks, a success rate of lower completion deployment, or a production rate.

Clause 8: The method of any one of clauses 1-7, further comprising providing one or more of: the drilling data from the one or more offset wells, the one or more drilling requirements associated with the wellbore, or the one or more completion requirements associated with the wellbore to the second machine learning model.

Clause 9: The method of any one of clauses 1-8, further comprising: providing additional drilling data for the wellbore to the first machine learning model; and determining one or more revisions to the updated geological model associated with the wellbore with the first machine learning model based on the additional drilling data.

Clause 10: The method of clause 9, further comprising generating a second geosteering recommendation with the second machine learning model based on the one or more revisions to the updated geological model associated with the wellbore and the additional drilling data.

Clause 11: A method of training a model architecture for management of geosteering of a wellbore, comprising: training a first machine learning model to generate a first output, wherein the first output is an updated geological model; providing drilling data from one or more offset wells, one or more drilling requirements associated with the wellbore, and one or more completion requirements associated with the wellbore to a second machine learning model; providing the first output to the second machine learning model; and training the second machine learning model to generate a second output based on the first output and the drilling date from the one or more offset wells, one or more drilling requirements associated with the wellbore, and the one or more completion requirements associated with the wellbore, wherein the second output is a geosteering recommendation.

Clause 12: The method of clause 11, further comprising: providing additional drilling data for the wellbore to the first machine learning model; and training the first machine learning model to determine one or more revisions to the updated geological model associated with the wellbore based on the additional drilling data.

Clause 13: The method of any one of clauses 11-12, wherein the first machine learning model is trained with training data, the training data comprising one or more of: a static geological model, the drilling data for the wellbore, or historical data associated with one or more historical wellbores.

Clause 14: The method of any one of clauses 11-13, further comprising training the second machine learning model to generate a ranking associated with the geosteering recommendation for the wellbore.

Clause 15: The method of any one of clauses 11-14, wherein the geosteering recommendation comprises a predicted rate of penetration, a number of drilling trips, one or more drilling risks, a success rate of lower completion deployment, or a production rate.

Clause 16: The method of any one of clauses 11-15, wherein the updated geological model associated with the wellbore comprises one or more geomechanical parameters of the wellbore, including a mechanical deformation parameter, a stress parameter, a strain parameter, a propensity for fracture parameter, or a propensity for fault parameter.

Clause 17: The method of any one of clauses 11-16, wherein the updated geological model associated with the wellbore associated with the wellbore comprises a predicted production rate of the wellbore.

Clause 18: A processing system, comprising: a memory comprising computer-executable instructions; and a processor configured to execute the computer-executable instructions and cause the processing system to perform a method in accordance with any one of Clauses 1-17.

Clause 19: A processing system, comprising means for performing a method in accordance with any one of Clauses 1-17.

Clause 20: A non-transitory computer-readable medium storing program code for causing a processing system to perform the steps of any one of Clauses 1-17.

Clause 21: A computer program product embodied on a computer-readable storage medium comprising code for performing a method in accordance with any one of Clauses 1-17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for management of geosteering of a wellbore, comprising:
processing one or more inputs with a first machine learning model trained to infer an updated geological model associated with the wellbore;
processing with a second machine learning model trained to generate a geosteering recommendation for the wellbore, one or more of: the updated geological model, drilling data from one or more offset wells, one or more drilling requirements associated with the wellbore, or one or more completion requirements associated with the wellbore to the second machine learning model; and
outputting the geosteering recommendation for the wellbore.

2. The method of claim 1, further comprising generating a ranking associated with the geosteering recommendation for the wellbore.

3. The method of claim 1, wherein the one or more inputs comprise one or more of: a static geological model or the drilling data for the wellbore.

4. The method of claim 1, wherein the updated geological model associated with the wellbore comprises one or more geomechanical parameters of the wellbore, including a mechanical deformation parameter, a stress parameter, a strain parameter, a propensity for fracture parameter, or a propensity for fault parameter.

5. The method of claim 1, wherein the updated geological model associated with the wellbore comprises a predicted production rate of the wellbore.

6. The method of claim 1, further comprising sending, to a field equipment, the geosteering recommendation for the wellbore.

7. The method of claim 1, wherein the geosteering recommendation comprises a predicted rate of penetration, a number of drilling trips, one or more drilling risks, a success rate of lower completion deployment, or a production rate.

8. The method of claim 1, further comprising providing one or more of: the drilling data from the one or more offset wells, the one or more drilling requirements associated with the wellbore, or the one or more completion requirements associated with the wellbore to the second machine learning model.

9. The method of claim 1, further comprising:
providing additional drilling data for the wellbore to the first machine learning model; and
determining one or more revisions to the updated geological model with the first machine learning model based on the additional drilling data.

10. The method of claim 9, further comprising generating a second geosteering recommendation with the second machine learning model based on the one or more revisions to the updated geological model and the additional drilling data.

11. A method of training a model architecture for management of geosteering of a wellbore, comprising:
training a first machine learning model to generate a first output, wherein the first output is an updated geological model;
providing drilling data from one or more offset wells, one or more drilling requirements associated with the wellbore, and one or more completion requirements associated with the wellbore to a second machine learning model;
providing the first output to the second machine learning model; and
training the second machine learning model to generate a second output based on the first output and the drilling date from the one or more offset wells, one or more drilling requirements associated with the wellbore, and the one or more completion requirements associated with the wellbore, wherein the second output is a geosteering recommendation.

12. The method of claim 11, further comprising:
providing additional drilling data for the wellbore to the first machine learning model; and
training the first machine learning model to determine one or more revisions to the updated geological model based on the additional drilling data.

13. The method of claim 11, wherein the first machine learning model is trained with training data, the training data comprising one or more of: a static geological model, the drilling data for the wellbore, or historical data associated with one or more historical wellbores.

14. The method of claim 11, further comprising training the second machine learning model to generate a ranking associated with the geosteering recommendation for the wellbore.

15. The method of claim 11, wherein the geosteering recommendation comprises a predicted rate of penetration, a number of drilling trips, one or more drilling risks, a success rate of lower completion deployment, or a production rate.

16. The method of claim 11, wherein the updated geological model associated with the wellbore comprises one or more geomechanical parameters of the wellbore, including a mechanical deformation parameter, a stress parameter, a strain parameter, a propensity for fracture parameter, or a propensity for fault parameter.

17. The method of claim 11, wherein the updated geological model associated with the wellbore comprises a predicted production rate of the wellbore.

18. A processing system, comprising: a memory comprising computer-executable instructions; and a processor configured to execute the computer-executable instructions and cause the processing system to:
process one or more inputs with a first machine learning model trained to infer an updated geological model associated with a wellbore;
process with a second machine learning model trained to generate a geosteering recommendation for the wellbore, one or more of: the updated geological model, drilling data from one or more offset wells, one or more drilling requirements associated with the wellbore, or one or more completion requirements associated with the wellbore to the second machine learning model; and
output the geosteering recommendation for the wellbore.

19. The processing system of claim 18, wherein the processor is further configured to cause the processing system to generate a ranking associated with the geosteering recommendation for the wellbore.

20. The processing system of claim 18, wherein the processor is further configured to cause the processing system to:
provide additional drilling data for the wellbore to the first machine learning model;
determine one or more revisions to the updated geological model with the first machine learning model based on the additional drilling data; and
generate a second geosteering recommendation with the second machine learning model based on the one or more revisions to the updated geological model and the additional drilling data.
